(19) United States
(12) Patent Application Publication
(10) Pub. No.: US 2006/0109136 A1
(43) Pub. Date: May 25, 2006

(54) Aesthetic Cover For Smoke Alarm

(76) Inventors: Monica Sumlin, Trotwood, OH (US); Rodney Sumlin, Trotwood, OH (US)

Correspondence Address: A PATENT LAWYER CORP, PC;R WILLIAM GRAHAM, 22 S ST CLAIR ST, DAYTON, OH, 45402, US

(21) Appl. No.: 10/904,638

(22) Filed: Nov. 19, 2004

(51) Int. Cl. G08B 23/00; G08B 17/00; G08B 17/10; G09F 3/10

(52) U.S. Cl. 340/693.5; 340/628; 340/632; 340/584; 40/299.01

(57) ABSTRACT

An aesthetic cover for use on one of a smoke alarm, oxygen sensor, carbon monoxide and heat detector includes a connector configured to connect to a portion of the detector in a retaining manner, wherein the connector is configured to provide substantially free air exchange between ambient air outside the connector to the detector, an aesthetic housing serve as a cover to substantially preclude direct frontal viewing of said connector and the detector when connected thereto an is connected to said connector in a manner to preclude the impedance of the substantially free air exchange, the housing formed with a first exterior surface having a sport type configuration and a second exterior surface configured to display a particular subset indicia thereon which is associated with the sport type configuration on the first housing.

### BACKGROUND OF THE INVENTION

1. Field of Invention

The present invention relates generally to an aesthetic cover for a smoke alarm or the like. More particularly, the invention is directed to an aesthetic cover for a smoke alarm or the like with an interchangeable piece for displaying various memorabilia indicia.

2. Prior Art

Today, a business or a house requires the use of multiple smoke, carbon monoxide, or heat detectors mounted throughout the structure as they provide a significant safety benefit. Such detectors typically include a cover with limited aesthetic appeal. There remains a need for a detector cover with an aesthetically pleasing appearance and which is multifunctional in order to be commercially acceptable and viable to produce.

### SUMMARY OF THE INVENTION

It is an object of this invention to improve the appearance of a cover for a smoke, carbon monoxide, heat detector or the like.

It is another object of this invention to provide a decorative cover for a smoke, carbon monoxide, heat detector or the like with aesthetically pleasing interchangeable parts.

It is still another object of this invention to provide an aesthetic cover for a smoke, carbon monoxide, or heat detector which does not impede functionality thereof.

Accordingly, the present invention is directed to an aesthetic cover for one of a smoke alarm, oxygen sensor carbon monoxide, and heat detector. The cover can include a sleeve configured to engage, e.g., frictionally retain, a portion of the detector, wherein the sleeve is configured with one or more open surfaces to provide substantially free air exchange between ambient air outside the sleeve and the detector.

Connected to an outer portion of the sleeve is an aesthetic housing serving as a cover to substantially preclude direct frontal viewing of the connector and the detector when connected thereto. The housing can preferably be diametrically larger than the diameter of the sleeve and detector to cover the same when affixed in an operative position and extends only part of an axial length of the sleeve to preclude the impedance of the substantially free air exchange. The housing can be formed with a first exterior surface which is of a sport type configuration and a second exterior surface which enables interchangeable parts to applied thereto, wherein each interchangeable part can include an exterior formed with a particular entity's indicia thereon which is associated with such type of sport configuration on the first housing.

In one embodiment, the first surface can be formed with a configuration which is one of a baseball, a basketball, a football and a racing tire, for example, and the second surface can be a surface area of a predetermined size to receive a substrate having an adhesive backing of a size to generally fit the second surface and includes one of a team's or individual's indicia which participates in such sport. For example, the substrate can include a New York Yankee sticker applied to a baseball configuration and so on. Optionally, the interchangeable part can be a molded part with such indicia and such part can be formed in a manner to quickly connect to the first surface, such as a snap fit.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a front view of one embodiment of the present invention;

FIG. 2 is a side view of the embodiment in FIG. 1;

FIG. 3 is a back view of the embodiment in FIG. 1;

FIG. 4 is a sectional view of the embodiment in FIG. 1;

FIG. 5 depicts another embodiment;

FIG. 6 depicts still another embodiment; and

FIG. 7 depicts yet another embodiment.

### DETAIL DESCRIPTION OF THE EMBODIMENTS

Referring now to the drawings, the aesthetic cover for a smoke alarm, oxygen sensor, carbon monoxide or heat detector or the like is generally designated by the numeral 10. The aesthetic cover 10 can include a sleeve 12 to connect the cover 10 to a portion of the detector D. For example, it is conceived that the sleeve 12 can have an inner diameter to frictionally engage an outer diameter of a housing of the detector D which is typically mounted to a ceiling or wall. Optionally, the sleeve 12 can be formed to engage in a manner to replace an existing housing of the detector D. Preferably, the sleeve 12 is configured with a plurality of open surfaces 14 to provide substantially free air exchange between ambient air outside the sleeve 12 and the detector D.

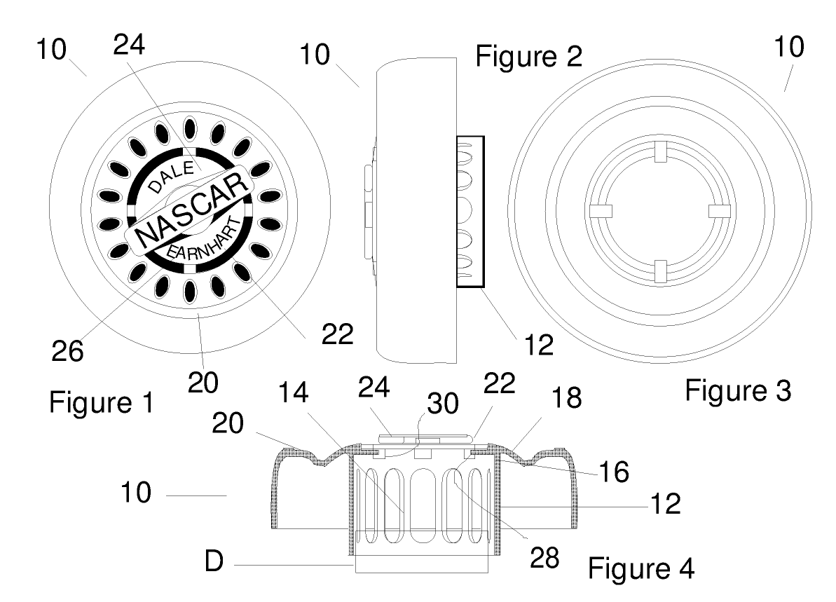

Connected to a portion 16 of the sleeve 12 is an aesthetic housing 18 which serves as a cover to substantially preclude direct frontal viewing of the sleeve 12 and the detector D as seen in FIG. 1 and when connected thereto. The housing 18 can preferably be diametrically larger than the diameter of the sleeve 12 and detector D and extends only part of an axial length of the sleeve 12 so as to preclude impedance of the substantially free air exchange to the detector D. The sleeve 12 serves as a connector between the housing 18 and the detector D and maintains the same in a manner in order to assure such air exchange. The housing 18 in the embodiment seen FIGS. 1-4 is shown as a racing tire by way of example. Embodiments 50, 60 and 70 in FIGS. 5, 6 and 7, respectively, illustrate the housing can be in the form of a football, basketball and baseball respectively. These are intended to be illustrative of the invention and not necessarily limiting in scope.

The housing 18 is formed with a first exterior surface 20 which is of a type of sport configuration and can include indicia related thereto, for example, a racing wheel tire configuration. The housing 18 also includes a second exterior surface 22 which enables interchangeable parts to be applied thereto. For example, each interchangeable part can include an exterior formed with a particular entity's indicia thereon which is associated with such type of sport configuration on the first exterior surface 20 of the housing 18.

As illustrated in the other embodiments, the first exterior surface 20 can be one of a baseball, a basketball, and a football configuration, for example. The second exterior surface 22 can be an integral surface area or a connectable portion and can be of a predetermined size to receive a substrate 24 having an adhesive backing of a size to generally fit on the second surface 22. For example, one side of the substrate 24 and includes an indicia 26 of a particular individual or team which participates in such sport. For example, the substrate 24 such as a sticker bears indicia NASCAR® Dale Earnhart®. FIGS. 5-7 show alternative indicia, for example, a New York Yankee sticker applied to a baseball housing, NBA sticker applied to a basketball housing, NFL sticker applied to a football housing and so on. Thus, the second exterior surface 22 includes a subset indicia corresponding to the sport type configuration on the first exterior surface 20.

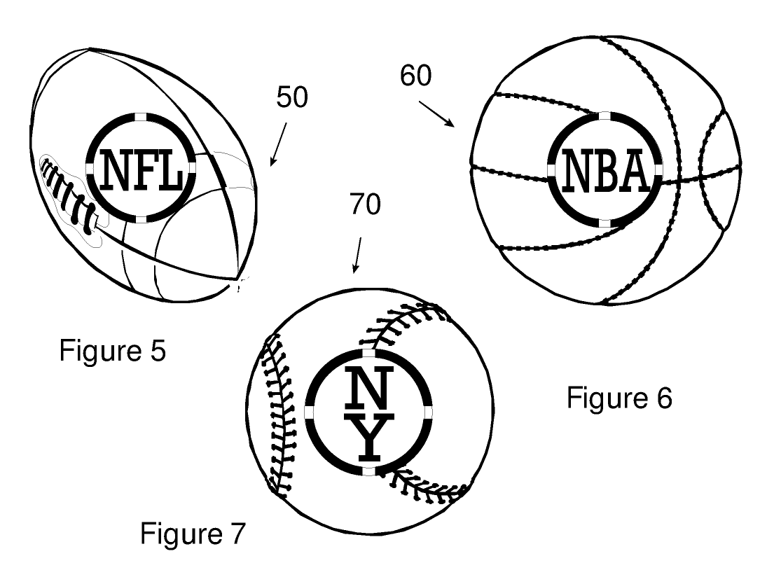

Optionally, as seen in FIG. 4, the second surface 22 can be an interchangeable part can which can be a molded part with such indicia formed in the surface thereof and such part can be formed in a manner to quickly connect to the first surface 20, such as a snap fit. In this case, the first exterior surface 20 can include an opening 28 of a less diameter than that of the second surface 22. A plurality of fingers 30 extend rearwardly from the second exterior surface 22 and are spatially positioned from each other proximate the sixe of the opening 28. The finger 30 are configured to bend thereby enabling insertion through the opening 28 where upon passing therethrough the fingers 30 spring back to a normal position to retain the second surface 22 against the first surface 20. It is contemplated that the cover 10 can be made of plastic or other suitable material.

Therefore, the cover 10 provides a unique device with the capability of interchangeable pieces for displaying various memorabilia, e.g., sports memorabilia, indicia of a desired individual or team and is well suited for use in homes, business, school hallways or other institutions. It is understood that while certain forms of this invention have been illustrated and described, it is not limited thereto except insofar as such limitations are included in the following claims and allowable functional equivalents thereof.

What is claimed is:

1. An aesthetic cover for use on one of a smoke alarm, carbon monoxide, oxygen sensor and heat detector, which includes:
a connector configured to connect to a portion of the detector in a retaining manner, wherein said connector is configured to provide substantially free air exchange between ambient air outside said connector to said detector; and
an aesthetic housing connected to a portion of said connector and serve as a cover to substantially preclude direct frontal viewing of said connector and said detector when connected thereto an is connected to said connector in a manner to preclude the impedance of the substantially free air exchange, said housing formed with a first exterior surface having a sport type configuration and a second exterior surface configured to display a particular subset indicia thereon which is associated with said sport type configuration on said first housing.

2. The aesthetic cover of claim 1, wherein said connector is a sleeve having at least one open surface to provide said substantially free air exchange.

3. The aesthetic cover of claim 1, wherein said second exterior surface is an interchangeable part having an exterior formed with said indicia thereon.

4. The aesthetic cover of claim 1, wherein said second exterior surface includes a sticker bearing said indicia.

5. The aesthetic cover of claim 1, wherein said sport type configuration is a baseball.

6. The aesthetic cover of claim 1, wherein said sport type configuration is a racing wheel tire.

7. The aesthetic cover of claim 1, wherein said sport type configuration is a basketball.

8. The aesthetic cover of claim 1, wherein said sport type configuration is a football.

9. The aesthetic cover of claim 3, wherein said interchangeable part is configured to quick connect to said first exterior surface.

10. The aesthetic cover of claim 1, wherein said housing is diametrically larger than diameters of said connector and said detector and extends only part of an axial length of the connector.
